(19) United States
(12) Patent Application Publication
(10) Pub. No.: US 2024/0314896 A1
(43) Pub. Date: Sep. 19, 2024

(54) BACKSPLASH WIRELESS POWER SYSTEM

(71) Applicant: Midea Group Co., Ltd., Beijiao (CN)

(72) Inventors: Daniel J. Trice, Louisville, KY (US); Brian M. Langness, Shelbyville, KY (US)

(21) Appl. No.: 18/182,773

(22) Filed: Mar. 13, 2023

(51) Int. Cl. H05B 6/12; F24C 15/30

(52) U.S. Cl. CPC H05B 6/1236; F24C 15/30; H05B 6/1245; H02J 50/10

(57) ABSTRACT

A backsplash wireless power system is mountable to a backsplash of a wall cabinet that is positioned adjacent to and above a countertop and includes a wireless power transmitter capable of powering a wirelessly powered appliance positioned proximate thereto.

### BACKGROUND

A wide variety of kitchen appliances are commonly used in single-family and multi-family residential applications. Many of these appliances, e.g., dishwashers, wine coolers, refrigerators, laundry washing machines, ovens, ranges, cooktops, etc., are installed in a “built-in” fashion such as under a countertop, within a cut-out formed in the countertop, or in a designated opening in the arrangement of kitchen cabinets. Built-In appliances are often hard-wired into a household electrical circuit or are plugged in to a dedicated electrical outlet that is generally hidden from view when the appliance is in its installed location.

Many consumers, however, also rely on various smaller kitchen appliances to perform more specific tasks, including, for example, microwave ovens, rice cookers, blenders, mixers, food processors, toasters, air fryers, pressure cookers, coffee makers, espresso machines, etc. While sometimes these appliances are stored on the countertop when not in use, in other instances these appliances may be stored in the cabinets or elsewhere and brought out when needed. To power such devices, many kitchens include electrical outlets on the wall between the upper cabinets and the countertop, which is often referred to as a backsplash, so that such appliances may be plugged in when needed. The power cords used by such appliances, however, can be cumbersome and unsightly, both during use and in storage.

More recently, it has been proposed to use wireless power for smaller kitchen appliances, e.g., based upon the Ki Kitchen Cordless Standard developed by the Wireless Power Consortium. Rather than relying on a power cord plugged into an electrical outlet, a wirelessly-powered appliance includes a wireless power receiver that is oriented on the bottom of the appliance to receive power wirelessly from a wireless power transmitter that is embedded in a cooktop, a countertop or table when the appliance is positioned directly over the wireless power transmitter.

Integrating a wireless power transmitter into a countertop or table in an existing kitchen, however, can be problematic and expensive. Many wireless power transmitters, for example, are intended to be installed underneath or within a countertop and are hard-wired into a household electrical circuit, so existing countertops may need to be removed, and new wiring run, in order to retrofit a kitchen for wireless power. Therefore, a substantial need exists in the art for a more cost effective and convenient manner of supplying power to a wirelessly powered appliance, particularly in an existing kitchen.

### SUMMARY

The herein-described embodiments address these and other problems associated with the art by providing a backsplash wireless power system that is mountable to a backsplash area of a wall, e.g., above a countertop, and in some instances, below an upper cabinet, and that includes a wireless power transmitter capable of powering a wirelessly powered appliance positioned proximate thereto. In some instances, the wireless power transmitter may be disposed on a movable platform that is movable between storage and use positions or configurations relative to a fixed base that is mounted to the backsplash, such that the movable platform may be moved out of the way when not in use, thereby reducing clutter and clearing the countertop for other uses.

Therefore, consistent with one aspect of the invention, a backsplash wireless power system may include a base configured to mount to a backsplash adjacent to and above a countertop, and a wireless power transmitter supported by the base and configured to generate a wireless power signal to power a wirelessly powered appliance positioned proximate thereto.

Some embodiments may further include a movable platform movably coupled to the base, and the wireless power transmitter is disposed on the movable platform. Also, in some embodiments, the movable platform is at least partially pivotably movable relative to the base. Further, in some embodiments, the movable platform is movable between a storage position and a use position. In some embodiments, when in the use position the wireless power transmitter is upwardly-facing to oppose a downwardly-facing wireless power receiver of the wirelessly powered appliance. Also, in some embodiments, when in the use position the wireless power transmitter is downwardly-facing to oppose an upwardly-facing wireless power receiver of the wirelessly powered appliance. In some embodiments, when in the use position the wireless power transmitter is side-facing to oppose a side-facing wireless power receiver of the wirelessly powered appliance. Further, in some embodiments, when in the storage position at least a portion of the movable platform nests within the base.

Some embodiments may also include an automated retraction/extension mechanism coupling the movable platform to the base and configured to move the movable platform between the storage and use positions. In some embodiments, when in the use position, the movable platform is supported by the countertop. Some embodiments may further include a releasable latching mechanism configured to releasably secure the movable platform in the storage position.

In addition, some embodiments may further include a power cord configured to supply power to the wireless power transmitter from a wall-mounted electrical outlet. In addition, some embodiments may also include a mounting bracket configured to mount the base to the backsplash.

Some embodiments may also include a secondary function configured for use when the wireless power transmitter is not active. In some embodiments, the secondary function includes an on/off light, a motion activated light, a timed light, a light sensor-activated light, a smart assistant, a video system, a display, a touchscreen display, a clock, a timer, a wired charging port, or an audio system. In addition, some embodiments may also include a user interface and a controller configured to operate the user interface and the wireless power transmitter, and the controller is further configured to control a functional operation of the wirelessly powered appliance using the interface. In addition, some embodiments may further include one or more power outlets disposed on the base and configured to supply power to a wired electronic device.

In addition, some embodiments may also include at least one plug configured to plug into a wall-mounted electrical outlet on the backsplash, and the backsplash wireless power system is at least partially supported by the wall-mounted electrical outlet. Some embodiments may also include one or more fasteners securing the backsplash wireless power system to the wall-mounted electrical outlet.

Further, in some embodiments, the wireless power transmitter is configured to supply power to a wirelessly powered appliance including an electric motor and/or a heating element and lacking a power storage element sufficient to otherwise power the wirelessly powered appliance. In addition, in some embodiments, the wireless power transmitter is further configured to inductively heat a utensil placed in proximity to the wireless power transmitter.

Other embodiments may include various methods for making and/or using any of the aforementioned constructions.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a room incorporating a backsplash wireless power system consistent with some embodiments of the invention.

FIG. 2 is a block diagram of an example control system for the backsplash wireless power system of FIG. 1.

FIGS. 3 and 4 are side cross sectional views of an example pull-out and tilt-down backsplash wireless power system consistent with some embodiments of the invention, in storage (FIG. 3) and use (FIG. 4) configurations.

FIGS. 5 and 6 are front elevational views of the example pull-out and tilt-down backsplash wireless power system of FIGS. 3-4, in storage (FIG. 5) and use (FIG. 6) configurations.

FIG. 7 is a front elevational view of another example backsplash wireless power system consistent with some embodiments of the invention, and including various secondary functions.

FIG. 8 is a front elevational view of another example backsplash wireless power system consistent with some embodiments of the invention, and supported in part by an electrical outlet.

FIGS. 9 and 10 are side cross sectional views of the example backsplash wireless power system of FIG. 8, in storage (FIG. 9) and use (FIG. 10) configurations.

FIG. 11 is a side cross sectional view of another example backsplash wireless power system consistent with some embodiments of the invention, and used for providing wireless power through the side of a wirelessly powered appliance.

FIG. 12 is a side cross sectional view of another example backsplash wireless power system consistent with some embodiments of the invention, and used for providing wireless power through the top of a wirelessly powered appliance.

### DETAILED DESCRIPTION

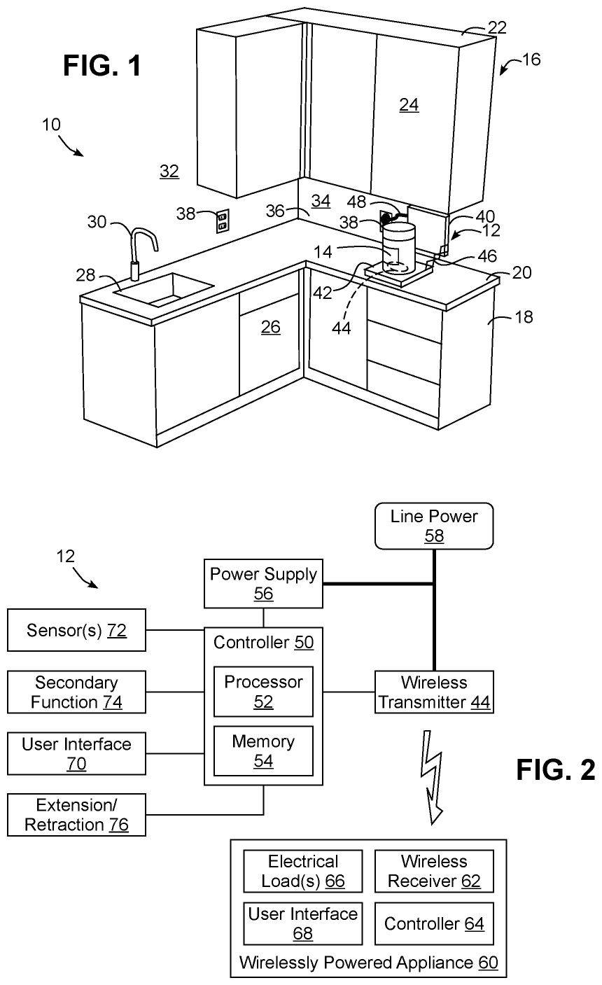

Turning now to the drawings, wherein like numbers denote like parts throughout the several views, FIG. 1 illustrates an example room (e.g., a kitchen) 10 within which is installed a backsplash wireless power system 12 suitable for powering one or more wirelessly powered appliances, e.g., a wirelessly powered pressure cooker 14. Room 10 includes a built-in cabinet system 16, which includes one or more base cabinets 18 that support a countertop 20 and one or more upper or wall cabinets 22 that are positioned over countertop 20. Cabinets 18, 22 may include doors, e.g., door 24, in some instances, or may include drawers or open shelves, and it will be appreciated that in some instances, various built-in appliances (e.g., dishwasher 26) may also be mounted or positioned within built-in cabinet system 16 (other appliances include, but are not limited to, refrigerators, ovens, ranges, cooktops, laundry washing machines, dryers, etc.) One or more sinks 28 may also be disposed on countertop 20 and may be supplied with water by a faucet 30.

Cabinets 18, 22 are generally secured along one or more walls 32, 34 in room 10, with wall cabinets 22 generally mounted to walls 32, 34 and positioned above counter height, e.g., above countertop 20, which is supported by base cabinets 18. In the United States, for example, the countertop may be at a height (from the floor) of approximately 36 inches with the wall cabinets at a height (from the floor) of approximately 54 inches, such that the wall area between the countertop and the bottom of the wall cabinets, referred to herein as a backsplash 36, has a height (from the countertop to the bottom of the wall cabinets) of approximately 18 inches. Base cabinets 18 may or may not be secured to walls 32, 34, but are otherwise generally floor standing such that their load is predominantly borne by the floor rather than a wall, which is generally the case for wall cabinets 22.

It will be appreciated that other countertop, wall cabinet, and backsplash heights may be used in other embodiments. It will also be appreciated that room 10 may be any suitable living or working space within which may be provided built-in cabinets including one or more wall cabinets positioned over a countertop, and within which it may be desired to use a wirelessly powered appliance. Example types of suitable rooms include a kitchen, bar, entertainment area, office area, retail establishment, etc. In some embodiments, room 10 may even be disposed within a boat or recreational vehicle.

Room 10 may also include one or more electrical outlets 38, e.g., disposed on walls 32, 34. In many kitchens, for example, electrical outlets are positioned at various points along a backsplash 36 to provide users with multiple locations within which to plug in various small, portable and/or countertop appliances.

Backsplash wireless power system 12, in the illustrated embodiments, is mounted to and supported at least in part by backsplash 36. In the embodiment of FIG. 1, for example, backsplash wireless power system 12 includes a fixed base 40 that is mounted to backsplash 36, and a movable platform 42 that includes a wireless power transmitter 44 (occluded by pressure cooker 14 in FIG. 1) and that is movably supported by a scissor mechanism 46. A power cord 48, plugged into an electrical outlet 38, supplies power to backsplash wireless power system 12, although in other embodiments the backsplash wireless power system may be hard-wired.

When not in use, movable platform 42 may be moved proximate to or in contact with fixed base 40, and scissor mechanism 46 may be collapsed into one or both of fixed base 40 and movable platform 42 to present a clean and uncluttered appearance in the storage position. Then, when it is desirable to use wirelessly powered appliance 14, movable platform 42 may be pulled out and tilted downwardly from fixed base 40, extending scissor mechanism 46, and exposing wireless power transmitter 44. Wirelessly powered appliance 14 may then be placed on movable platform 42 in alignment with wireless power transmitter pad 44, and power may be supplied to the wirelessly powered appliance. In some embodiments, movable platform 42 may be pulled out and tilted down until it is supported on countertop 20 such that wirelessly powered appliance 14 is effectively supported on countertop 20, while in other embodiments, movable platform 42 may extend only partially towards the countertop, whereby the weight of wirelessly powered appliance 14 would be supported by backsplash wireless power system 12.

Now turning to FIG. 2, backsplash wireless power system 12 may be under the control of a controller 50 that receives inputs from a number of components and drives a number of components in response thereto. Controller 50 may, for example, include one or more processors 52 and a memory 54 within which may be stored program code for execution by the one or more processors. The memory may be embedded in controller 50, but may also be considered to include volatile and/or non-volatile memories, cache memories, flash memories, programmable read-only memories, read-only memories, etc., as well as memory storage physically located elsewhere from controller 50, e.g., in a mass storage device or on a remote computer interfaced with controller 50. Controller 50 may also be implemented at least in part using discrete circuit logic, as will be appreciated by those of ordinary skill having the benefit of the instant disclosure.

As shown in FIG. 2, controller 50 may be powered by a power supply 56, e.g., an AC-DC power supply that is coupled to line power 58 (e.g., 120-240 VAC, as may be provided by a residential electrical circuit), via an electrical outlet and plug, or alternatively, a hard-wired connection. Line power 58 also supplies wireless power transmitter 44 with power. Controller 50 may control wireless power transmitter 44 to selectively activate/deactivate the wireless power transmitter, to regulate the power output of the wireless power transmitter, to communicate data to and/or receive data from wirelessly powered appliance 14, etc. In the illustrated embodiment, wireless power transmitter 44 is compatible with the Ki Kitchen Cordless Standard developed by the Wireless Power Consortium, although other wireless power or charging standards may be used in other embodiments, including, for example, the Qi Wireless Charging Standard also developed by the Wireless Power Consortium. It will be appreciated that the control over wireless power transmitter 44 by controller 50 to emit a wireless power signal would be well within the abilities of those of ordinary skill having the benefit of the instant disclosure.

A wirelessly powered appliance 60 (of which pressure cooker 14 of FIG. 1 is an example) may include a wireless power receiver 62 that, when positioned proximate wireless power transmitter 44, receives a wireless power signal to supply power to the wirelessly powered appliance. Wirelessly powered appliance 60 may also include a controller 64 to operate wireless power receiver 62, as well as to perform other appliance-related functions. Power received by wireless power receiver 62 may be used to also power one or more electrical loads 66, e.g., motors, heating elements, displays, etc., as well as controller 64 itself.

In some embodiments, wirelessly powered appliance 60 may include a user interface 68 to operate the appliance, and, beyond the supply of wireless power, may operate completely independently from backsplash wireless power system 12. In other embodiments, however, backsplash wireless power system 12 may be functionally integrated with wirelessly powered appliance 60, e.g., such that a user interface 70 of backsplash wireless power system 12 is used to display information received from wirelessly powered appliance 60 and/or control one or more functional operations of wirelessly powered appliance 60 beyond simply controlling the supply of power to the wirelessly powered appliance. In some embodiments, for example, wirelessly powered appliance 60 may omit any separate user interface, and may be operated through user interface 70 of backsplash wireless power system 12. Communication between backsplash wireless power system 12 and wirelessly powered appliance 60 may be over a Near Field Communication (NFC) wireless link as supported by the Ki standard, or via a separate wired or wireless network.

It may also be desirable to provide one or more sensors 72 for sensing various states associated with the backsplash wireless power system 12. For example, a position sensor may be used in some embodiments to detect when backsplash wireless power system is in a storage and/or use configuration, e.g., to automatically turn the backsplash wireless power system on or off when it is transitioned between the storage and use configurations. In addition, a temperature sensor and/or current may be used in some embodiments to monitor wireless power transfer and prevent overheating. Other suitable sensors will be appreciated by those of ordinary skill having the benefit of the instant disclosure.

In addition, as will be discussed in greater detail below, backsplash wireless power system 12 may also support one or more secondary functions represented at 74. Such secondary functions may include functions that are available to a user when backsplash wireless power system 12 is in a storage configuration, is in a use configuration, or both. Non-limiting examples of secondary functions that may be supported by backsplash wireless power system 12 include lights (including on/off, motion activated, or night lights), clocks, kitchen timers, smart assistants, displays, video systems, audio systems, additional wall outlets and/or wired charging ports, etc.

Furthermore, backsplash wireless power system 12 may also include an automated extension/retraction mechanism 76 capable of transitioning platform 42 between the storage and use configurations. In addition, in some embodiments, wireless power transmitter 44 may also be capable of serving as an inductive power source for cooking, such that, for example, if a suitable pot or pan is placed on the wireless power transmitter, the wireless power transmitter operates as an induction cooktop to generate heat for cooking food. As such, induction cooktop controls and/or displays may also be provided in backsplash wireless power system 12 in some embodiments.

It should be appreciated that wireless power is distinguished from wireless charging in the context of the present disclosure, as while a backsplash wireless power system may in some instances provide power to charge a battery of an appliance or other electronic device wirelessly coupled to the wireless power system, such a use is secondary to providing wireless power to operate the appliance, i.e., to provide the primary power supply to the appliance during its active use. As such, a wirelessly powered appliance in many instances may not include any battery or other power storage element capable of independently providing sufficient power to operate the wirelessly powered appliance, such that the wirelessly powered appliance is effectively inoperable unless coupled to a wireless or wired power source (since some wirelessly powered appliances may also be capable of being plugged in). For many wirelessly powered appliances used for cooking for example, high power draw electrical loads such as electric motors and/or heating elements may be used, and to the extent any power storage element is present on such a wirelessly powered appliance, it is incapable of sufficiently powering such high power draw electrical loads, such that the wirelessly powered appliance is principally powered through a backsplash wireless power system as described herein.

A backsplash wireless power system consistent with the invention may therefore generally be considered to include at least a base that is mountable to a backsplash that is positioned adjacent and above a countertop, along with a wireless power transmitter supported by the base and configured to generate a wireless power signal to power a wirelessly powered appliance positioned proximate thereto. A base, in particular, may be considered to be mountable to a backsplash when the base is sized and configured, and in some instances, includes suitable mounting hardware, for securing the base to the backsplash.

Mounting may occur through the use of fasteners and/or adhesives, and mounting may be made to any structure of a backsplash providing suitable support. Mounting, for example, may be made through the use of threaded fasteners that extend into the surface of a backsplash in some embodiments. In addition, in some embodiments, additional mounting hardware may be used to mount a base to a backsplash, e.g., one or more mounting brackets, and in some embodiments a base may be removably attachable to a mounting bracket such that a bracket may first be mounted to a backsplash and the base thereafter attached to the mounting bracket to complete the installation. The base and/or mounting bracket may also include, in some embodiments, a structure suitable for hiding a portion of a power cord, e.g., when the base is secured to a backsplash directly adjacent an electrical outlet such that any extra length of power cord can be hidden from view. In some embodiments, the base may be secured directly to a portion of the wall outlet.

In addition, in some instances, a wireless power transmitter may be disposed on a movable platform that is movable relative to the base between storage and use positions. When in the use position, the movable platform orients the wireless power transmitter in a convenient location to oppose a wireless power receiver on a wirelessly powered appliance. In some instances, the movable platform may be positioned to support the weight of the wirelessly powered appliance, e.g., when the movable platform is suspended above the countertop, or in other instances, the movable platform may itself be supported on the countertop such that the countertop supports the weight of the moveable platform and the wirelessly powered appliance supported thereby. In still other instances, the movable platform may position the wireless power transmitter to oppose a wireless power receiver of a wirelessly powered appliance when the wirelessly powered appliance is supported directly on the countertop.

When in the storage position, however, the movable platform may be moved out of the way, e.g., nesting at least partially into the fixed base and up against the backsplash, to reduce clutter and clear the countertop for other uses. Thus, wireless power functionality may be supported in an existing kitchen or other room in a manner that is easily retrofittable and reasonably clutter free.

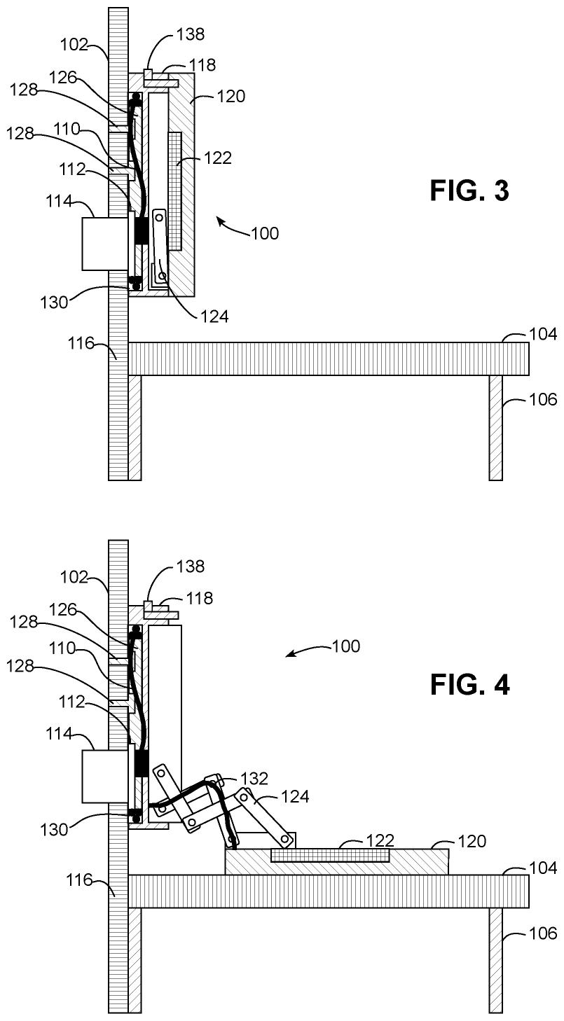

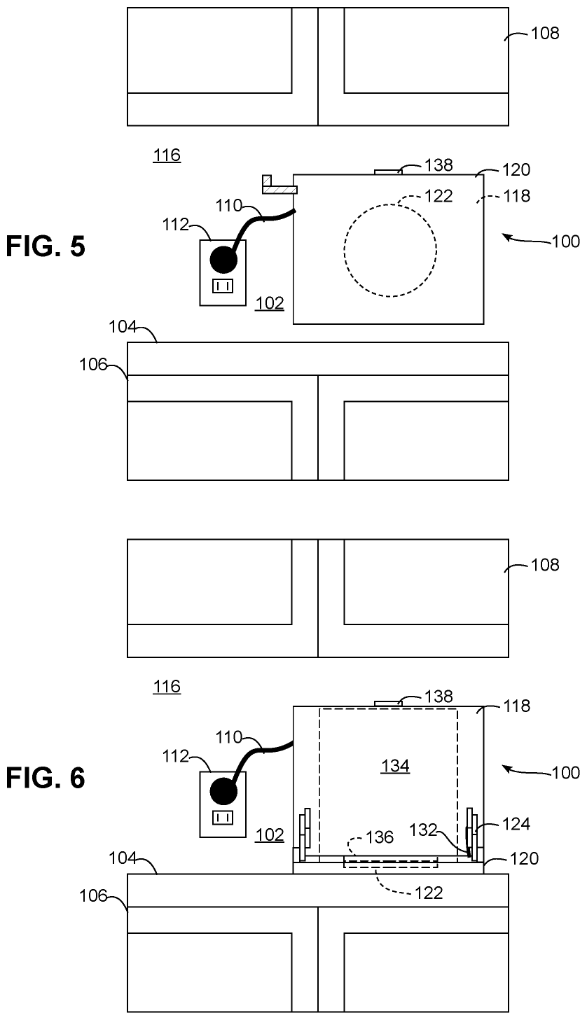

FIGS. 3-6, for example, illustrate an example pull-out and tilt-down backsplash wireless power system 100 consistent with the invention, which is illustrated as mounted to a backsplash 102 above a countertop 104 supported by a base cabinet 106, and in some instances, below an upper wall cabinet 108 (FIGS. 5-6). Backsplash wireless power system 100 is supplied with power by a power cord 110 that is plugged in to an electrical outlet 112 housed in a junction box 114 positioned on backsplash 102 of a wall 116. It will be appreciated that in some embodiments, backsplash 102 may be tiled or otherwise may include various decorative surface features, which have been omitted from FIGS. 3-6 for clarity.

Backsplash wireless power system 100 includes a fixed base 118 and a movable platform 120 that includes a wireless power transmitter 122 and that is movably supported by a scissor mechanism 124. Other manners of providing rotational and/or linear motion to transition movable platform 120 from the storage configuration nested within fixed base 118 down to countertop 104 may be used in other embodiments, including pivots, hinges, sliding rails, pistons, etc. It will be appreciated that a bias mechanism may also be provided in some embodiments to bias the movable platform 120 to either its storage position (FIGS. 3 and 5) or use position (FIGS. 4 and 6), and that a damping mechanism, e.g., via one or more cylinders, may also be used to provide controlled movement between the storage and use positions. It may also be desirable to provide a releasable latching mechanism 138 in some embodiments to latch movable platform 120 to fixed base 118 to prevent the movable platform 120 from inadvertently dropping into the use position.

In some embodiments, it may be desirable to design movable platform 120 to nest into fixed base 118 when in a storage position (FIGS. 3 and 5) to reduce the distance that movable platform projects outwardly from backsplash 102. As also illustrated in FIGS. 3 and 5, it may be desirable for aesthetic purposes to design fixed base 118 and/or movable platform 120 such that the hardware used to couple the two components together (e.g., scissor mechanism 124) to be covered by fixed base 118 and/or movable platform 120 when in the storage configuration. It will be appreciated, however, that a wide variety of other profiles and ornamental designs may be used in other embodiments.

Fixed base 118 is mounted to backsplash 102 using a mounting bracket 126 that is secured to wall 116 using a plurality of fasteners 128 (e.g., screws or bolts). Fixed base 118 may then be attached to mounting bracket 126, e.g., through snap-in tabs, fasteners, magnets, rails, etc. Alternatively, no separate mounting bracket may be used, and fasteners 128 may anchor fixed base 118 directly to wall 116. It will be appreciated, however, that an innumerable number of other mounting configurations may be used in other embodiments, so the invention is not limited to the particular mounting configurations described herein.

In addition, where backsplash wireless power system 100 is powered through a power cord 110, it may also be desirable to provide a space around mounting bracket 126 and/or fixed base 118 to wrap any extra length of power cord (illustrated at 130). Furthermore, when power cord 110 extends to fixed base 118, some or all of the electrical components, other than wireless power transmitter 122, may be disposed in fixed base 118, and a cable 132 (FIGS. 4 and 6) may extend between fixed base 118 and wireless power transmitter 122 to power the wireless power transmitter. In other embodiments, at least some of all of the electrical components may be disposed in movable platform 120, and in other embodiments, all of the electrical components may be disposed in movable platform 120, such that fixed base 118 may not receive any electrical power, and power cord 110 may instead couple to movable platform 120.

In use, backsplash wireless power system 100 is normally stored in the configuration illustrated in FIGS. 3 and 5, with movable platform 120 nested within fixed base 118. When it is desired to power a wirelessly powered appliance, movable platform 120 may be pulled out and tilted down from the storage position or configuration (FIGS. 3 and 5) to the use position or configuration (FIGS. 4 and 6) and a wirelessly powered appliance 134 may be positioned on movable platform 120 with its wireless power receiver 136 aligned with wireless power transmitter 122. Power may then be supplied to the wirelessly powered appliance 134, e.g., automatically after detection of wireless power receiver 136 by wireless power transmitter 122, or manually after user selection of an “on” function supported by backsplash wireless power system 100 or wirelessly powered appliance 134. Once use of wirelessly powered appliance 134 is complete, wirelessly powered appliance 134 may be removed from movable platform 120 and movable platform 120 may then be tilted up and pushed into its storage position.

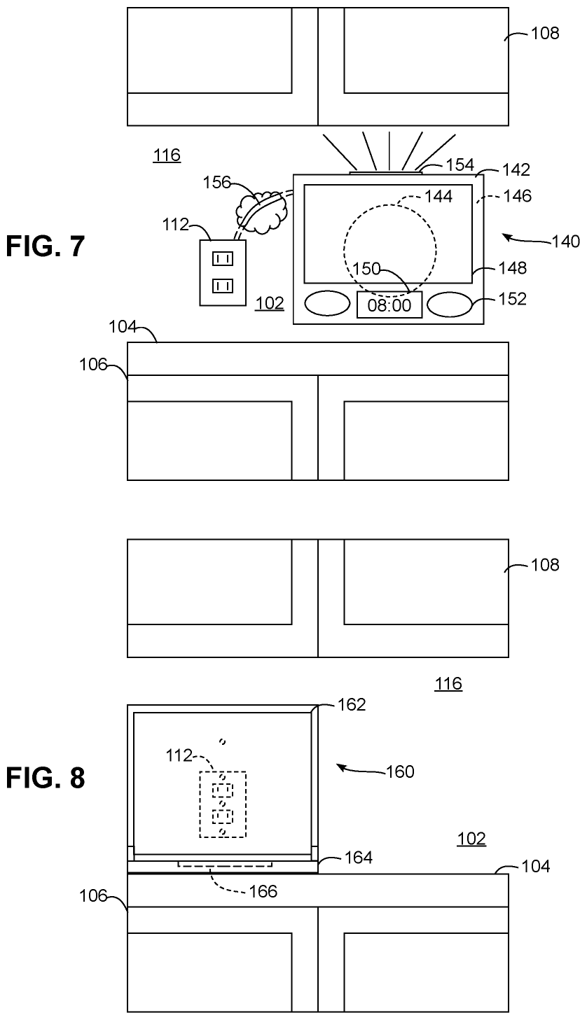

FIG. 7 next illustrates another backsplash wireless power system 140, which includes various secondary functions that may be implemented in different embodiments. Specifically backsplash wireless power system 140 of FIG. 7 is illustrated in a storage position, with a movable platform 142 including a wireless power transmitter 144 nested within a fixed base 146 that is secured to backsplash 102 of wall 116 and positioned above a countertop 104 supported by a base cabinet 106.

Backsplash wireless power system 140 in the illustrated embodiment supports a number of secondary functions, including, for example, a touchscreen display 148, which in addition to providing display functionality, may also serve as a user interface configured to receive user input. In some embodiments, touchscreen display 148 may be implemented as a tablet computer, and may provide, for example, recipes, internet browsing, weather information, nutritional information, audio/video playback and other functions commonly provided by tablet computer and other personal computing devices. Network connectivity, e.g., through wireless or powerline networks, may also be supported. Given the orientation of backsplash wireless power system 140 in a storage configuration, in many instances it may be desirable to orient secondary functions on an outwardly-facing surface of movable platform 142, i.e., the surface that faces down and/or contacts countertop 104 when in a use configuration.

In addition, in some embodiments, backsplash wireless power system 140 may provide a smart assistant function, and may be configured to present audio and/or video information to a user in some embodiments, e.g., on touchscreen display 148. Additional displays, e.g., a clock display 150, may also be provided, as may one or more audio playback devices, e.g., speakers 152. A light 154 may also be mounted to backsplash wireless power system 140, e.g., to provide under-cabinet lighting, task lighting, countertop lighting, ambient lighting, night lighting, etc., and which may be operated manually, based on motion, based upon a timer, and/or based upon a light sensor.

An innumerable number of other secondary functions may be supported in other embodiments, and it will be appreciated that any of the aforementioned secondary functions may be implemented collectively or individually in different embodiments. It will also be appreciated that secondary functions are generally used principally when the wireless power transmitter is not active and/or when the movable platform is in the storage position. However, such secondary functions, in some instances, may still be used when the wireless power transmitter is active and/or when the movable platform is in the use position.

FIG. 7 also illustrates another variation, whereby rather than being powered by a power cord plugged in to electrical outlet 112, backsplash wireless power system 140 may be hard-wired to an electrical circuit, as represented by wire 156 shown running within wall 116.

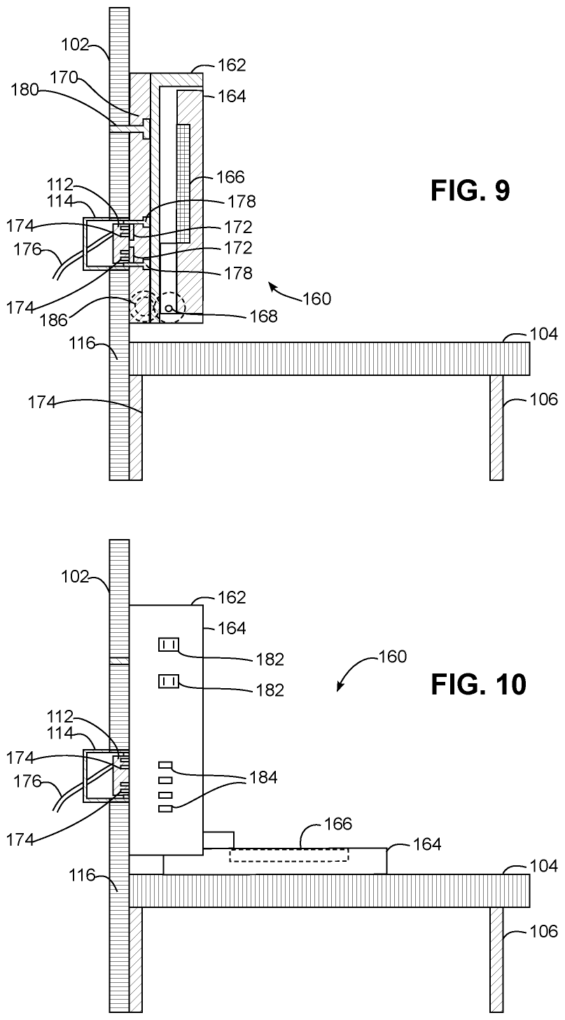

FIGS. 8-10 next illustrate another example backsplash wireless power system 160 that is in-part supported by an electrical output such as electrical outlet 112, with FIGS. 8 and 9 illustrating backsplash wireless power system 160 in a storage position or configuration, and FIG. 10 illustrating backsplash wireless power system 160 in a use position or configuration. Backsplash wireless power system 160 includes a fixed base 162 and a movable platform 164 that includes a wireless power transmitter 166. In this embodiment, rather than relying on a scissors mechanism to pivot movable platform 164 between the storage and use positions, backsplash wireless power system 160 utilizes a hinge 168 such that movable platform 164 pivots about a pivot axis defined through hinge 168.

Fixed base 162 is supported on backsplash 102 by a mounting bracket 170, although in some embodiments no separate mounting bracket may be used. In addition, rather than utilizing a power cord, backsplash wireless power system 160 includes one or more plugs 172 that engage with sockets 174 in electrical output 112, such that power supplied to electrical output 112, e.g., by an in-wall power line 176, is supplied through sockets 174 to plugs 172.

In addition, sockets 174 additionally provide some structural support to backsplash wireless power system 160, and in this regard, it may be desirable to utilize one or more fasteners, e.g., fasteners 178, to secure mounting bracket 170 to electrical socket 112, e.g., through existing threaded apertures used to mount the electrical outlet 112 to junction box 114, or to mount a faceplate (which in some embodiments may be removed) to electrical outlet 112.

In some embodiments, electrical outlet 112 may provide sufficient structural support to backsplash wireless power system 160, while in other embodiments, additional structural support may be desired, e.g., using one or more fasteners 180 securing mounting bracket 170 to wall 116.

It will be appreciated that in the embodiment of FIGS. 8-10, use of electrical outlet 112 to support backsplash wireless power system 160 covers the electrical outlet and renders it unusable for supplying power to other kitchen appliances. Therefore, as illustrated in FIG. 10, it may also be desirable in some embodiments to provide one or more electrical sockets 182 on one or both sides of backsplash wireless power system 160 to provide a consumer with replacement power outlets for powering wired electronic devices. In addition, it may also be desirable to provide wired charging connections, e.g., USB ports 184 on one or both sides of backsplash wireless power system 160.

In addition, backsplash wireless power system 160 is illustrated as including an automated extension/retraction mechanism 186, e.g., a motor and a gear train, to transition movable platform 164 between the storage and use positions. In some embodiments, a button or other user control may be used to initiate such a transition.

It should be noted that, while in some embodiments movable platform 164 may be suspended above countertop 104, in many embodiments it may be desirable to have movable platform 164 supported on countertop 104, generally given the weight of many wirelessly-powered appliances, or where induction cooking is supported, pots, pans and other utensils for cooking food.

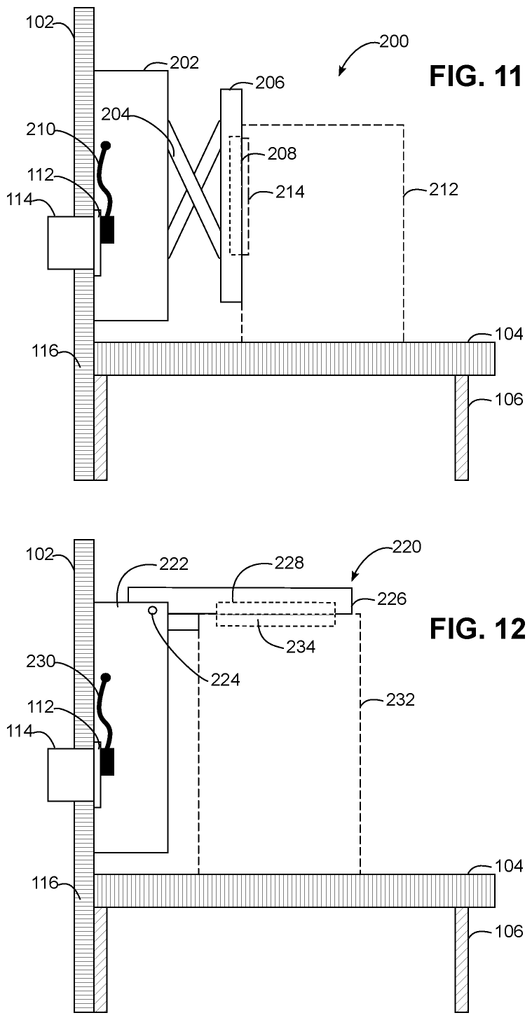

Next, turning to FIGS. 11 and 12, it will be appreciated that a backsplash wireless power system consistent with the invention may also be configured to provide wireless power to a wirelessly powered appliance having wireless power receivers disposed at different locations and/or in different orientations on the wirelessly powered appliance. FIG. 11, in particular, illustrates another backsplash wireless power system 200, including a fixed base 202 joined through a scissors mechanism 204 to a movable platform 206 having a wireless power transmitter 208. Fixed base 202 is mounted to backsplash 102 of wall 116, and is supplied with power by a power cord 210 that is plugged in to electrical outlet 112. Rather than having an upwardly-facing wireless power transmitter to oppose and provide power to a downwardly-facing wireless power receiver of a wirelessly powered appliance, wireless power transmitter 208 is side-facing to provide power to a wirelessly powered appliance 212 having a side-facing wireless power receiver 214 opposing wireless power transmitter 208.

Similarly, FIG. 12 illustrates another backsplash wireless power system 220, including a fixed base 222 joined through a rotatable coupling 224 to a movable platform 226 having a wireless power transmitter 228. Fixed base 222 is mounted to backsplash 102 of wall 116, and is supplied with power by a power cord 230 that is plugged in to electrical outlet 112. Rather than having an upwardly-facing wireless power transmitter to oppose and provide power to a downwardly-facing wireless power receiver of a wirelessly powered appliance, wireless power transmitter 228 is downwardly-facing to provide power to a wirelessly powered appliance 232 having an upwardly-facing wireless power receiver 234 opposing wireless power transmitter 228.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A backsplash wireless power system, comprising:
a base configured to mount to a backsplash adjacent to and above a countertop; and
a wireless power transmitter supported by the base and configured to generate a wireless power signal to power a wirelessly powered appliance positioned proximate thereto.

2. The backsplash wireless power system of claim 1, further comprising a movable platform movably coupled to the base, wherein the wireless power transmitter is disposed on the movable platform.

3. The backsplash wireless power system of claim 2, wherein the movable platform is at least partially pivotably movable relative to the base.

4. The backsplash wireless power system of claim 2, wherein the movable platform is movable between a storage position and a use position.

5. The backsplash wireless power system of claim 4, wherein when in the use position the wireless power transmitter is upwardly-facing to oppose a downwardly-facing wireless power receiver of the wirelessly powered appliance.

6. The backsplash wireless power system of claim 4, wherein when in the use position the wireless power transmitter is downwardly-facing to oppose an upwardly-facing wireless power receiver of the wirelessly powered appliance.

7. The backsplash wireless power system of claim 4, wherein when in the use position the wireless power transmitter is side-facing to oppose a side-facing wireless power receiver of the wirelessly powered appliance.

8. The backsplash wireless power system of claim 4, wherein when in the storage position at least a portion of the movable platform nests within the base.

9. The backsplash wireless power system of claim 4, further comprising an automated retraction/extension mechanism coupling the movable platform to the base and configured to move the movable platform between the storage and use positions.

10. The backsplash wireless power system of claim 4, wherein when in the use position, the movable platform is supported by the countertop.

11. The backsplash wireless power system of claim 2, further comprising a releasable latching mechanism configured to releasably secure the movable platform in the storage position.

12. The backsplash wireless power system of claim 1, further comprising a power cord configured to supply power to the wireless power transmitter from a wall-mounted electrical outlet.

13. The backsplash wireless power system of claim 1, further comprising a mounting bracket configured to mount the base to the backsplash.

14. The backsplash wireless power system of claim 1, further comprising a secondary function configured for use when the wireless power transmitter is not active.

15. The backsplash wireless power system of claim 1, wherein the secondary function comprises an on/off light, a motion activated light, a timed light, a light sensor-activated light, a smart assistant, a video system, a display, a touchscreen display, a clock, a timer, a wired charging port, or an audio system.

16. The backsplash wireless power system of claim 1, further comprising a user interface and a controller configured to operate the user interface and the wireless power transmitter, wherein the controller is further configured to control a functional operation of the wirelessly powered appliance using the interface.

17. The backsplash wireless power system of claim 1, further comprising one or more power outlets disposed on the base and configured to supply power to a wired electronic device.

18. The backsplash wireless power system of claim 1, further comprising at least one plug configured to plug into a wall-mounted electrical outlet on the backsplash, wherein the backsplash wireless power system is at least partially supported by the wall-mounted electrical outlet.

19. The backsplash wireless power system of claim 17, further comprising one or more fasteners securing the backsplash wireless power system to the wall-mounted electrical outlet.

20. The backsplash wireless power system of claim 1, wherein the wireless power transmitter is configured to supply power to a wirelessly powered appliance including an electric motor and/or a heating element and lacking a power storage element sufficient to otherwise power the wirelessly powered appliance.

21. The backsplash wireless power system of claim 1, wherein the wireless power transmitter is further configured to inductively heat a utensil placed in proximity to the wireless power transmitter.
